(19) United States
(12) Patent Application Publication
(10) Pub. No.: US 2007/0065102 A1
(43) Pub. Date: Mar. 22, 2007

(54) System and method for detecting real-time change in an image

(76) Inventor: Richard H. Laughlin, Grapevine, TX (US)

Correspondence Address: HITT GAINES P.C., P.O. BOX 832570, RICHARDSON, TX, 75083, US

(21) Appl. No.: 11/228,182

(22) Filed: Sep. 16, 2005

(51) Int. Cl. H04N 7/00

(52) U.S. Cl. 386/95

(57) ABSTRACT

A video processing and display system and a method of capturing and displaying video. In one embodiment, the video processing and display system comprising a processor configured to: (1) compare a frame of a digital video stream at one point in time with a frame of the digital video stream at a previous point in time, the digital video stream representing a scene and (2) provide an image representing a difference therebetween, the difference indicating a change in the scene.

### TECHNICAL FIELD OF THE INVENTION

The present invention is directed, in general, to moving image capture and display systems and, more particularly, to a system and method, capable of implementation in a processor, such as a digital signal processor (DSP), for detecting real-time change in an image.

### BACKGROUND OF THE INVENTION

Video surveillance is being used more and more today. A problem arises when an operator observer has been viewing a monitor for a significant period of time or a group of monitors. When there has been no change in a monitor for a period of time, the observer loses his attention to detail and eventually the image, that he expects to see is burned into his mind. A second issues arises when the observer is required to view a plurality of monitors. Only one scene, monitor, may be changing but the operator must check all monitors to ensure there is not a target in that scene. If the observer can make a quick glance at the other monitors and determine that there is no cue and thus no new target or target motion then a greater time can be spent dwelling on the scene that is changing. It is also well documented that the probability of detection, recognition and identification is dependent upon the time studying the image.

There have been a multitude of schemes proposed to address this issue based on a variation in the scene. Unfortunately, none of these schemes takes into account the power of the human observer. The human mind connected to the eye is one of the most powerful computers known. It can interpolate data based on history. It can reject false alarms based on similar patterns. It can identify targets based on patterns and changes in patterns. It can interpolate missing pieces of data. The problem is that the mind gets bored when there are none of the above functions to perform.

Accordingly, what is needed in the art is a system and method capable of implementation in a processor, such as a DSP, for detecting real-time change in an image that takes advantage of the image-processing power of the human mind.

### SUMMARY OF THE INVENTION

To address the above-discussed deficiencies of the prior art, the present invention provides, in one aspect, a video processing and display system. In one embodiment, the video processing and display system comprising a processor configured to: (1) compare a frame of a digital video stream at one point in time with a frame of the digital video stream at a previous point in time, the digital video stream representing a scene and (2) provide an image representing a difference therebetween, the difference indicating a change in the scene. The processor may be configured to compare the frame of the digital video stream at the one point in time with the frame of the digital video stream at the previous point in time on a frame-by-frame basis, a line-by-line basis, a pixel-by-pixel basis, or any other basis upon which a comparison may be made.

In another aspect, the present invention provides a method of capturing and displaying video. In one embodiment, the method includes: (1) comparing a frame of the digital video stream at one point in time with a frame of the digital video stream at a previous point in time, the digital video stream representing a scene and (2) providing an image representing a difference therebetween, the difference indicating a change in the scene.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a block diagram of one embodiment of a video processing and display system and a method of capturing and displaying video constructed and carried out according to the principles of the present invention;

FIG. 2 illustrates a block diagram of another embodiment of a video processing and display system and a method of capturing and displaying video constructed and carried out according to the principles of the present invention;

FIG. 3 illustrates a block diagram of yet another embodiment of a video processing and display system and a method of capturing and displaying video constructed and carried out according to the principles of the present invention;

FIGS. 4A-4C together illustrate the provision of a differential image involving the subtraction of two images;

FIG. 5A-5F together illustrate differential images resulting from subtraction of a plurality of images;

FIG. 6 illustrates a block diagram of one embodiment of an exemplary frame storage and difference circuit;

FIG. 7 illustrates a block diagram of one embodiment of an exemplary cue enhancement circuit;

FIG. 8 illustrates a block diagram of one embodiment of an exemplary color enhancement circuit; and

FIG. 9 illustrates a block diagram of one embodiment of a software-based video processing and display system and a method of capturing and displaying video constructed and carried out according to the principles of the present invention.

### DETAILED DESCRIPTION

The illustrated embodiment of the video processing and display system of the present invention is configured such that it can indicate to an observer that a change has occurred in an image and where in the image the change may be found. It is known that the smaller the image area, and the fewer number of confusing objects, the more rapidly target recognition and identification occur. The detector that initially captures the image includes an imaging unit that receives incident light on an array of pixel elements provides a digital output corresponding to the incident light thereby generating a digital output signal. The imaging apparatus compares sequential pixel output signals from a single pixel, and generates a differential signal which forms an image of the difference between the present image and previous image(s). The present image and the differential image(s) are added together such that the differential image when presented to the observer cues the observer where the change(s) in the image/scene is occurring.

Because image signals and differential signals are generated simultaneously, and the magnitude of the differential signals can be varied based on the operator's judgment of the optimum contrast between the real time image and the differential signal, and various types of signal processing of the differential signal can be performed easily, the operator can optimize the image for cueing. A simple linear amplifier may be used for a uniform gain or a log amplifier may be used to emphasize small differential changes, by compressing the larger changes. In addition, the processing of the differential signal may include processing each of the red-green-blue (RGB) colors separately and differently. In the illustrated embodiment, a digital filter that enhanced the outline of the differential image is used to cue the operator to study that area of the image.

In the normal surveillance mode, the real time image is presented to the operator, and the differential signals are added (mixed) with the video signal. In the illustrated embodiment, the mixing is accomplished at the camera and only one signal is transmitted to the display. However, it may be desirable to transmit both the image signal and the difference signal to the display independently and mix the signals at the display to facilitate the operator adjustment of the processing of the difference signal.

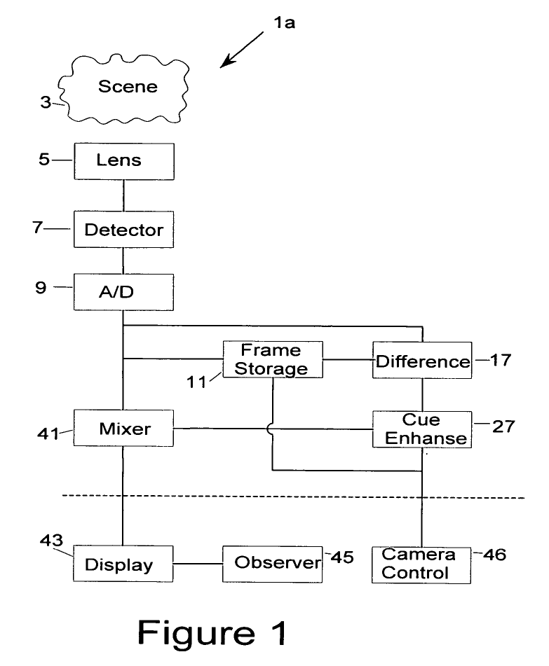

Referring initially to FIG. 1, illustrated is a block diagram of one embodiment of a video processing and display system and a method of capturing and displaying video constructed and carried out according to the principles of the present invention.

The illustrated video processing and display system processes a digital video stream so as to extract a differential signal between frames of a digital video stream to process that signal and mix it back with the real-time digital video stream. The highlighted differential signal (image) is used to cue the operator that there has been a change in the scene and where that change has taken place. In the illustrated embodiment, the video processing and display system is an integral part of a digital imaging system. However, those skilled in the pertinent art will recognize that the change detector circuitry can be an onboard addition to a digital imaging system or an outboard unit that accepts the video in the various formats transmitted from the imaging system and processes the video signal to perform the change detection.

One illustrated embodiment of the video processing and display system compares the present video frame to a previous video frame. The illustrated video processing and display system then forms an image of the scene and simultaneously a differential image, of the change in the scene. When no change or only nominal change has occurred, there is essentially no image. When a change has occurred between the current frame and a previous reference frame, there is a positive image of the new target at its new position and a negative image of where the target was previously. This image is then mixed with the scene image and displayed to an operator.

In the illustrated embodiment, the difference signal is enhanced and the signal is processed by a digital filter so that the outline of the image is enhanced. The signal is then clipped to eliminate the negative image so that only the new position of the target is presented. Those skilled in the pertinent art will recognize that it may be beneficial in some operating conditions to clip the positive portion of the signal.

The present frame is compared to the six preceding frames in one illustrated embodiment. However, it may be advantageous to compare the present frame to a single earlier frame, or to processes and mix a plurality of difference signals (images) from a plurality of previous frames depending on the anticipated nature of the change and the speed of the change of the scene. One skilled in the pertinent art will also recognize that in some cases it may be desirable to selectively compare a plurality of frames other than all of the i-k frames.

FIG. 1 illustrates a lens 5 imaging a scene 3 onto a detector 7. In the illustrated embodiment, the detector 7 is a monochrome CCD camera. The analog output of the detector 7 focal plane array is processed by an analog-to-digital converter 9, which results in a digital video stream. The output of each pixel, in response to the intensity of the scene 3 at that point on the detector, is then represented by a binary number. In the illustrated embodiment, an 8-bit word is clocked out a serial port. This output is sent directly to a mixer 41, as the current frame, digital video stream and simultaneously to both the frame storage circuit 11 where the current frame and previous frames are stored, delayed and sent to the differencing unit 17. The frame storage circuit 11 stores each frame for a set number of frames to which is then passed on to the difference circuit 17 where they are differenced with current frame. The output of the difference circuit 17 is a new image of the change, only now placed in context in the scene. The location of the target in the previous frame(s) is represented by a negative image, and its present location is represented by a positive image. The output of the difference circuit 17 is passed to a cue image enhancement circuit 27. The cue image enhancement circuit 27 optimizes the difference image for operator cuing.

Those skilled in the pertinent art will recognize that the video processing and display system can operate without the cue image enhancement circuit 27. The enhanced difference image, at the output of the cue image enhancement circuit 27 is combined with the video image, of the present frame, from the output of the analog-to-digital converter 9 in the mixer 41.

The two combined images, the present video image and the enhanced difference image, are transmitted by a transmitter 49a to the display 43 for presentation to the observer 45. In the illustrated embodiment, the transmitter 49a is a composite video cable. An observer 45 controls the cue image enhancement circuit 27 features and the frame storage circuit 11, by means of a control 46. The control 46 is connected to the frame storage circuit 11 and the cue image enhancement circuit 27 by a second transmitter 49c. In the illustrated embodiment this is a control cable. Those skilled in the pertinent art will recognize that cables 49c and 49a can be any means of transmitting signals including a wireless link.

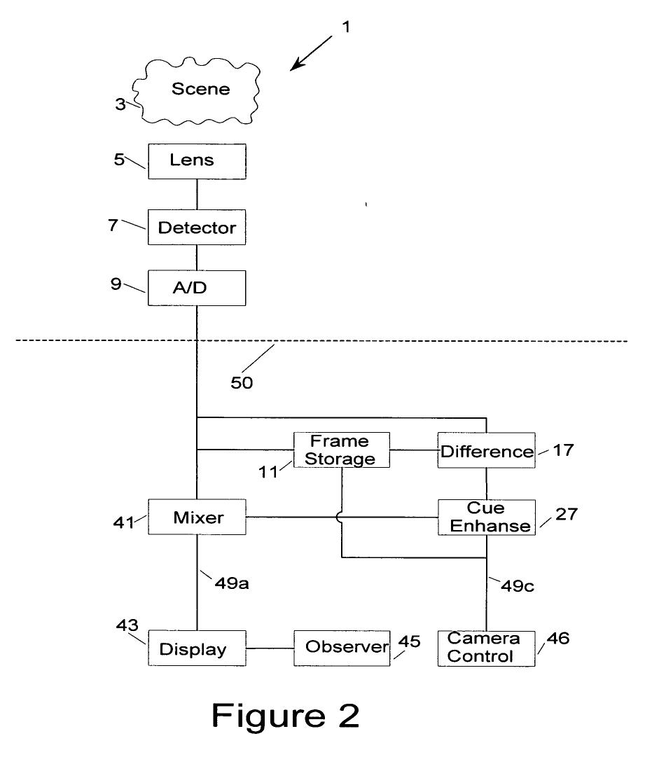

It should be recognized that the demarcation point for the transmitter 49 between the detector 7 and the remote display 43 may occur at different places in the system. Turning now to FIG. 2, illustrated is a block diagram of another embodiment of a video processing and display system and a method of capturing and displaying video constructed and carried out according to the principles of the present invention. In this configuration the demarcation point for the transmitter 50 is the output of the real time frame from the analog-to-digital converter 9. The transmitter 51 transmits the digital signal to the mixer 41, the frame storage circuit 11 and the difference circuit 17. This facilitates an independent control, by the operator, that can be inserted between a camera and its display.

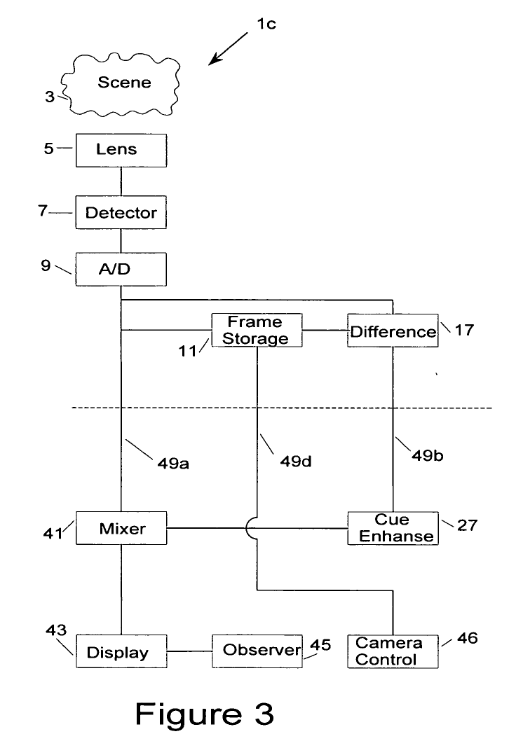

Turning now to FIG. 3, illustrated is another option with a differing demarcation point, for the configuration of the illustrated video processing and display system 1c. In this case, the point of demarcation for the remote display is after the analog-to-digital converter 9 and the difference circuit 17. The signal from the analog-to-digital converter 9 is transmitted by the transmitter 49a to the remote mixer 41. The signal from the difference circuit 17 is transmitted by a second transmitter 49c to the cue image enhancement circuit 27, and the signal from control 46 is transmitted by a third transmitter 49b to the frame storage circuit 11.

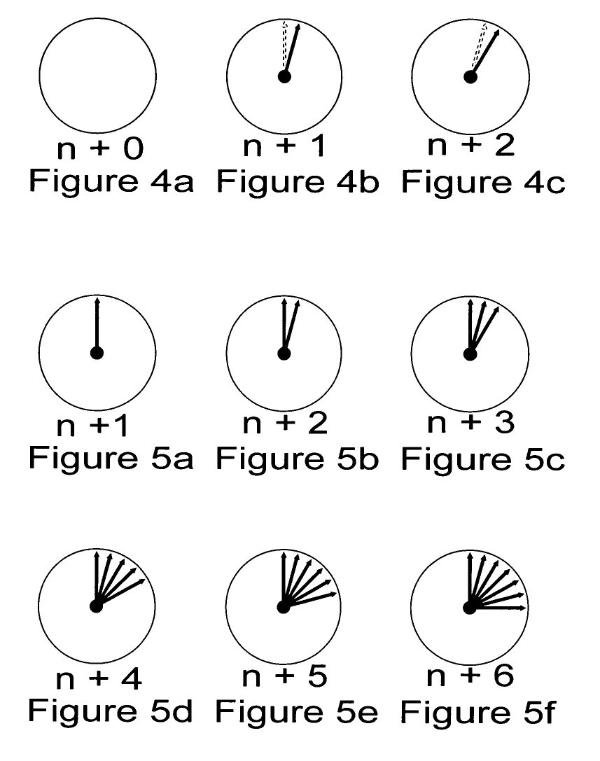

Turning now to FIGS. 4A-C, illustrated are the provision of a differential image involving the subtraction of two images. The human eye has a nominal response time of 60 milliseconds. As a result typical frame times of video systems are 30 frames/second (33 milliseconds) such that the display 43 does not appear to flicker to the observer 45. If the device only compares the nth frame to the n−1 frame, in some cases the observer 45 may not notice the cue. FIGS. 4A, 4B and 4C illustrate the difference image of a clock hand moving 150 per frame when comparing only two frames. At time “0,” shown in FIG. 4A, there would be no image as a result of no change. At time “0” plus 1 frame n+1, there is a negative image where the hand was and a positive image where the hand is at n+1, as shown in FIG. 4B. FIG. 4C at time “0” plus two frames, n+2, shows a negative image where there was a positive image at n+1 and a new positive image in the new position. These images, with the proper intensity settings, can result in a subtle but detectible presentation. If there were sufficient brightness compared to the rest of the scene, it could amount to a cue to the presence of a change.

Turning now to FIGS. 5A-5F, illustrated are differential images resulting from subtraction of a plurality of images. In this configuration, one of the differential images is clipped. In the illustrated embodiment, it is the negative image. The nth frame is delayed k field times, where k can take on a plurality of values. The nth frame is then differenced with all n−1, n-2, . . . n−k values. These differenced images are clipped to remove the negative image and summed together. In the first frame, there would be a single image FIG. 5A. At k=6 there would be six images. In the steady state environment of the preferred configuration, each image would remain on the screen for 0.2 minutes with the preferred setting of k. One skilled it the art will realize that it is advantageous to provide a control to set the value of k. In some cases, it might be advantageous to drop out a plurality of frames such that all of the frames from 1 to k are not summed.

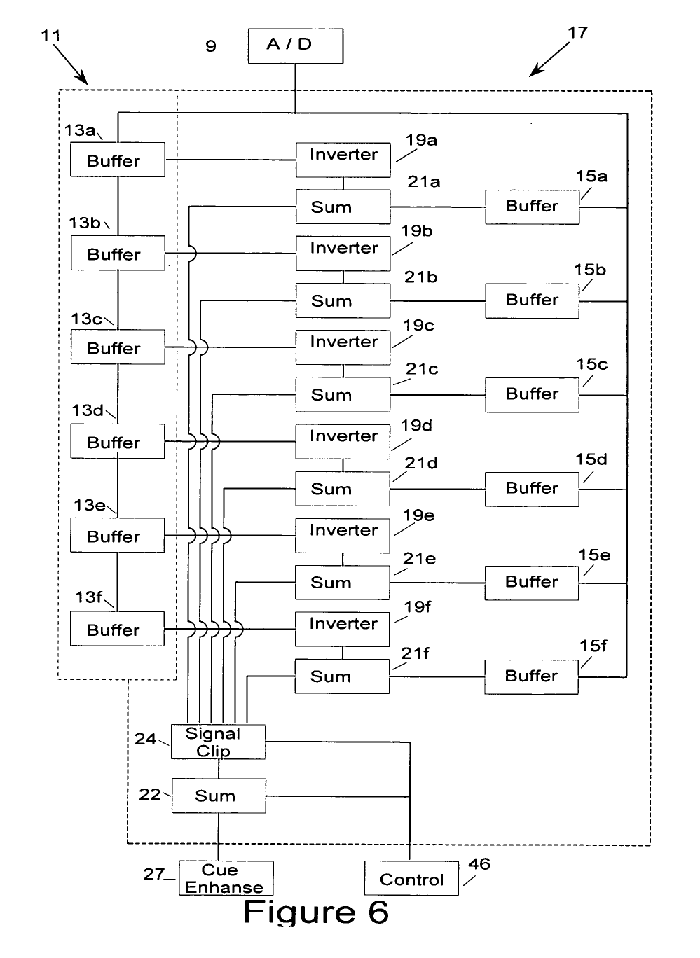

Turning now to FIG. 6, illustrated is a block diagram of one embodiment of an exemplary frame storage and difference circuit. The signal coming from the analog-to-digital converter 9 is split and sent to the first buffer 13a of the frame storage circuit 11 and all of the buffers 15a through 15k of the difference circuit 17. In the illustrated embodiment, the buffers 15a-f receive frame n-O simultaneously with the buffer 13a, as they are clocked out of the camera. Each buffer 13a-f is constructed such that it provides a delay of 1 frame. Such that the output of buffer 13a presents the frame from the time n-O, buffer 13b presents the frame from time n−1 repeating this pattern to buffer 13k presents the frame from the time n-k. The output of buffer 13a also presents the video frame to buffer 13b delayed one frame. The output of buffer 13b also presents its output to buffer 13c delayed by one frame for the output of buffer 13a and two frames from the input of buffer 13a. In like manor buffer 13k receives the output of 13(k−1) delayed k frames from the input of buffer 13a. One skilled in the pertinent art will recognize that the buffers 13 can be configured with delays corresponding to various numbers of frames, or partial frames. They could configured to delay by individual pixels or individual lines of the detector 7.

The buffers 15a-k delay the incoming frame by the inverter delay such that the first pulse of frame n arrives at the sum circuits 21a-k at the same time as the first pulse of frame n-k from the inverter 19. The output of the inverters 19a-k (frame n−1 through n−k, respectively) is presented to the sum circuits 21a-k where frame n is differenced with frame n−1 through frame n-k. The output of the sum circuits 21a-k is then simultaneously presented to a clipping circuit 24, where all of the negative components of the differential image are clipped (removed). The control signal can configure the clipping circuit 24 such that the positive components of the differential image are clipped so as to optimize the cueing. Each of the k clipped and delayed differential images at the output of the clip circuit 24 are transferred to a summing circuit 22, where all k frames are added together for a composite change image over time frame n−1 through n-k. A control signal is provide from the operator control 46 to select which frames n−1 to n-k will be summed and used as the cueing image.

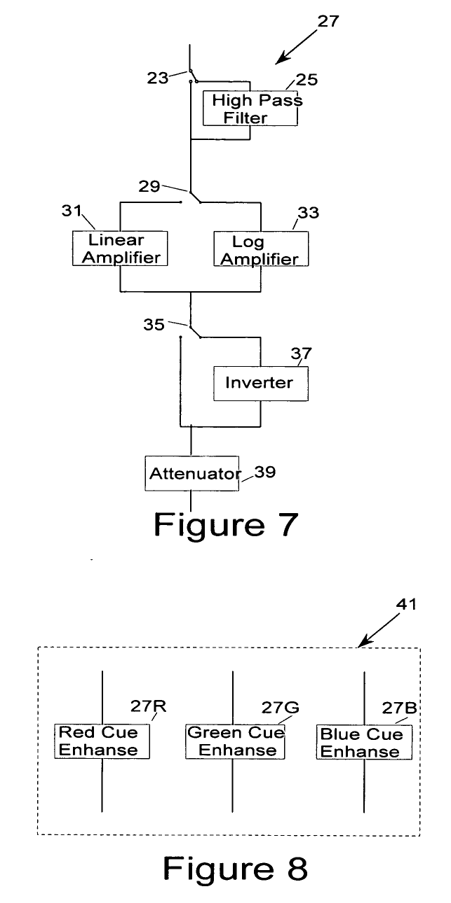

Turning now to FIG. 7, illustrated is a block diagram of one embodiment of an exemplary cue image enhancement circuit 27. While a cue image enhancement circuit 27 is not essential to the operation of the video processing and display system, the cue image enhancement circuit 27 allows the operator to enhance the cueing function such that an operator detects a change in the scene more rapidly. The composite of the delayed differential images from summing circuit 22 is presented to the cue image enhancement circuit 27. It first may be passed through a digital filter 25 to highlight the edges or boundary of the differential image.

Note that some configurations may incorporate a digital filter on each individual delayed differential image prior to summing the individual images. A selector switch 23 allows the operator to select or deselect the digital filter. Other specific filters may be added to enhance the outline of the change. The differential images are then passed through either a linear amplifier 31 or a log amplifier 33 selected by switch 29. The log amplifier 33 is used to emphasize the larger (more intense) changes in the image. The operator can also select using the selector switch 35 the use of the inverter 37 to optimize the contrast of the cue image with the real time image. The final element in the illustrated embodiment of the cue image enhancement circuit 27 is an attenuator 39 to balance the intensity of the cue (differential images) with the real time image. One skilled in the pertinent art will recognize that the order of processing elements can be rearranged or one or more of the elements can be eliminated and that there may be other functions that can be added to the cue image enhancement circuit 27 that would in specific scenes enhance the cueing function.

Turning now to FIG. 8, illustrated is a block diagram of one embodiment of an exemplary color enhancement circuit 47. The illustrated color enhancement circuit 47 incorporates three cue enhancement circuits 27 one for each of the three primary colors, red cue enhancement 27R, green cue enhancement 27G and blue cue enhancement 27B and adds a color balance 40. This provides the operator the ability to process each of the colors separately to enhance the cueing. Those skilled in the pertinent art will recognize that there may be other color combinations that can be used to enhance the cue or that conventional color balance and saturation circuits can be incorporated into the cue enhancement circuit 27.

FIGS. 6, 7 and 8 describe a flexible configuration where the operator can optimize the cueing of the illustrated video processing and display system. In specific applications, it may be advantageous to pre-select the specific configuration and eliminate the unused portions of the circuitry.

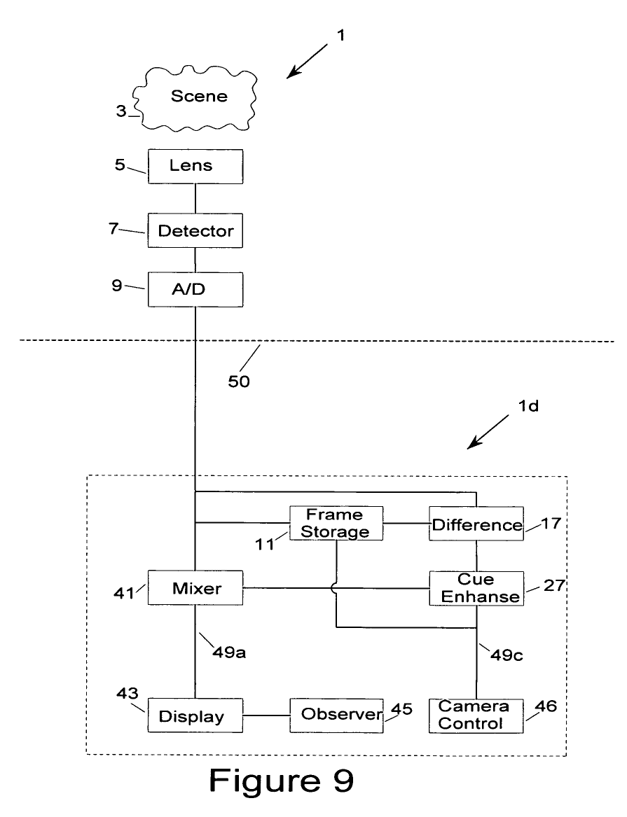

Turning now to FIG. 9, illustrated is a block diagram of one embodiment of a software-based video processing and display system and a method of capturing and displaying video constructed and carried out according to the principles of the present invention. More specifically, FIG. 9 shows a illustrated video processing and display system where the digitized video output of the detector 7 (camera) is provided to a computer (microprocessor) 52 and the hardware (hard-wired) frame storage circuit 11, difference 17, cue enhancement 27, mixer 41 described in FIGS. 6, 7 and 8 functions are accomplished, in software, by algorithms with in the computer 52.

Although the present invention has been described in detail, those skilled in the pertinent art should understand that they can make various changes, substitutions and alterations herein without departing from the spirit and scope of the invention in its broadest form.

What is claimed is:

1. A video processing and display system comprising a processor configured to:
compare a frame of a digital video stream at one point in time with a frame of said digital video stream at a previous point in time, said digital video stream representing a scene; and
provide an image representing a difference therebetween, said difference indicating a change in said scene.

2. The system as recited in claim 1 wherein said processor is further configured to provide an image that combines said difference with one of said frame at said one point in time.

3. The system as recited in claim 1 wherein said processor is further configured to compare said frame of said digital video stream at one point in time with a plurality of frames of said digital video stream at previous points in time and provide an image representing differences therebetween, said differences indicating changes in said scene.

4. The system as recited in claim 3 wherein said processor is further configured to provide an image that combines said plurality of differences with one of said frames at said one point in time.

5. The system as recited in claim 1 wherein a cable couples a detector configured to produce said digital video stream and said processor.

6. The system as recited in claim 1 wherein a wireless link couples a detector configured to produce said digital video stream and said processor.

7. The system as recited in claim 1 wherein a wireless link carries said image representing said differences.

8. The system as recited in claim 1 wherein said processor is further configured to enhance said difference.

9. The system as recited in claim 8 wherein said processor is configured to accept user commands to manipulate an enhancement of said difference.

10. The system as recited in claim 8 wherein said processor is permanently configured for enhancement of said difference.

11. The system as recited in claim 10 wherein said user commands are entered proximate said detector.

12. The system as recited in claim 10 wherein said user commands are entered remotely from said detector.

13. The system as recited in claim 10 wherein said user commands are hard-wired.

14. The system as recited in claim 1 further comprising a detector configured to produce said digital video stream, said detector being selected from the group consisting of:
a monochrome camera,
a color camera,
an infrared camera, and
an x-ray camera.

15. The system as recited in claim 1 further comprising a detector configured to produce said digital video stream, a common chassis enclosing said detector and said processor.

16. The system as recited in claim 1 further comprising a detector configured to produce said digital video stream, said detector and said processor being enclosed in separate chassis.

17. The system as recited in claim 1 wherein said processor is configured to compare said frame of said digital video stream at said one point in time with said frame of said digital video stream at said previous point in time on a selected one of:
a frame-by-frame basis,
a line-by-line basis, and
a pixel-by-pixel basis.

18. A method of capturing and displaying video, comprising:
comparing a frame of said digital video stream at one point in time with a frame of said digital video stream at a previous point in time, said digital video stream representing a scene; and
providing an image representing a difference therebetween, said difference indicating a change in said scene.

19. The method as recited in claim 18 further comprising providing an image that combines said difference with one of said frame at said one point in time.

20. The method as recited in claim 18 further comprising comparing said frame of said digital video stream at one point in time with a plurality of frames of said digital video stream at previous points in time and provide an image representing differences therebetween, said differences indicating changes in said scene.

21. The method as recited in claim 18 further comprising transmitting said digital video stream via a cable.

22. The method as recited in claim 18 further comprising transmitting said digital video stream via a wireless link.

23. The method as recited in claim 18 wherein a wireless link carries said image representing said differences.

24. The method as recited in claim 18 further comprising enhancing said difference.

25. The method as recited in claim 24 wherein said enhancing comprises accepting user commands to manipulate an enhancement of said difference.

26. The method as recited in claim 25 further comprising entering said user commands proximate said detector.

27. The method as recited in claim 25 further comprising entering said user commands remotely from said detector.

28. The method as recited in claim 25 wherein said user commands are hard-wired.

29. The method as recited in claim 18 wherein said digital video stream is produced by a detector selected from the group consisting of:
a monochrome camera,
a color camera,
an infrared camera, and
an x-ray camera.

30. The method as recited in claim 18 wherein a sequence of software instructions carry out said comparing and said providing said image representing said difference therebetween.

31. The method as recited in claim 18 wherein a sequence of software instruction carries out said comparing and said providing.

32. The method as recited in claim 31 wherein said processor is further configured to enhance said difference.

33. The method as recited in claim 32 wherein said processor is further configured to provide an image that combines said difference with one of said frame at said one point in time.

34. The method as recited in claim 32 wherein said processor is further configured to provide an image that combines said difference with one of said frames at said one point in time.
